(19) United States
(12) Patent Application Publication
(10) Pub. No.: US 2008/0126039 A1
(43) Pub. Date: May 29, 2008

(54) METHOD AND DEVICE FOR SIMULATING A VISUAL PATTERN OF A FIBER PRODUCT AND METHOD AND DEVICE FOR PRODUCING A BCF YARN

(75) Inventors: Bjorn Godderz, Kaltenkirchen (DE); Carsten Voigtlander, Muhbrook (DE); Matthias Schemken, Neumunster (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Oerlikon Textile GmbH & Co. KG

(21) Appl. No.: 11/939,221

(22) Filed: Nov. 13, 2007

Related U.S. Application Data
(63) Continuation of application No. PCT/EP2006/004490, filed on May 12, 2006.

(30) Foreign Application Priority Data
May 14, 2005 (DE) 10 2005 022 447.4

(51) Int. Cl. G06G 7/48; D01H 13/26

(52) U.S. Cl. 703/6; 57/264

(57) ABSTRACT

A method and an apparatus for simulating a visual surface pattern of a fiber product and a method and an apparatus for producing a multicolored BCF yarn. In this case, at least one parameter of a strand-like fiber bundle is sensed and is digitized into data which is converted with the aid of evaluation electronics into a surface pattern. The visual appearance of a longitudinal portion of the fiber bundle may be detected as an image as a parameter of the stand-like fiber bundle. A rapid and reproducible simulation of the visual surface pattern of a fiber product is consequently possible. Additionally, the production of the fiber product, for example a BCF yarn, can be monitored by means of the simulation results, so that at least one process parameter can be selected and/or monitored. For this purpose, an image acquisition appliance is provided, which is assigned to a bobbin or to the BCF yarn and which is connected to an evaluation device for an actual-value/desired-value comparison.

### CROSS-REFERENCE TO RELATED APPLICATIONS

The present application is a Continuation of International Application No. PCT/EP2006/004490, filed May 12, 2006, and which designates the U.S. The disclosure of the referenced application is incorporated herein by reference.

### FIELD OF THE INVENTION

The invention relates to a method for simulating a visual surface pattern of a fiber product and a device for carrying out the method, and to a method for producing a BCF yarn and a device for carrying out the method.

### BACKGROUND OF THE INVENTION

In the production of sheet-like fiber products, a strand-like fiber or fiber bundle is produced as a semi-finished product in a preceding separate process. The sheet-like fiber product can then be produced due to the further processing of the fibers and fiber bundles by knitting, weaving, plaiting, etc. in a following process. The nature, in particular the visual appearance, of the sheet-like fiber product is in this case influenced substantially by the nature of the fiber and its production process. Particularly in the production of carpets, it is known to use as fiber bundle a BCF (Bulked Continuous Filament) yarn which is formed from a plurality of differently colored multi-filament threads. Depending on the degree of intermixing of the individual fibers within the BCF yarn, different color patterns are obtained in the carpet fabric, and, for example in order to prevent individual colors from standing out, it is necessary for all the threads in the BCF yarn to be intermixed intensively.

So that, even when the fiber or fiber bundle is being produced, conclusions can be drawn as to a fiber product produced from it in a following process, simulation methods are known, in which surface patterns of the fiber product are calculated theoretically from parameters of the fiber bundle. Such a method for simulating a sheet-like fiber product is known from U.S. Pat. No. 5,680,333. In this case, the parameters of a BCF yarn, in the form of a number of the thread components, colors of the thread components and, in particular, a measure of the mix of the components, are used in order, with the aid of evaluation electronics and corresponding analysis algorithms, to simulate the appearance of a carpet produced from the BCF yarn. Methods of this type, however, are extremely complex and depend essentially on the data default setting. Moreover, defining and describing the selected parameters of the fiber bundle require special experience in order to obtain the variables critical for the subsequent appearance of the sheet-like fiber product.

An object of the invention, then, is to provide a method and an apparatus for simulating a visual surface pattern of a fiber product of the generic type, by means of which a simple and reproducible simulation of the visual appearance of the fiber product is possible.

A further aim of the invention is to provide a method and an apparatus for simulating a visual surface pattern of a fiber product, which can be integrated directly into a production process of a fiber bundle, so that defined process parameter settings can thus be carried out before or during the production process.

Accordingly, an object of the invention is also to develop a method and an apparatus for producing a BCF yarn in such a way that a yarn corresponding to the desired default settings of a surface pattern of a carpet can be produced.

### SUMMARY OF THE INVENTION

The above objects and others of the invention are achieved by means of a method for simulating a visual surface pattern of a fiber product, having the features as claimed in Claim 1, by means of an apparatus for carrying out the method, having the features as claimed in Claim 14, by means of a method for producing a BCF yarn, having the features as claimed in Claim 18, and by means of an apparatus for carrying out the method, as claimed in Claim 22.

Advantageous developments of the invention are defined by the features and feature combinations of the respective subclaims.

The invention is based on the recognition that the appearance of a sheet-like fiber product, for example a carpet, is characterized essentially by the appearance of the fiber. In this case, the production methods of the sheet-like fiber products generate a more or less predefined and regular depositing and interlinking of short longitudinal portions of the fiber bundle which contribute to the appearance on the surface of the fiber product. Particularly in the production of colored fiber bundles, it was found that there is a relationship between an image of a longitudinal portion of the fiber bundle and a visual surface pattern of the fiber bundle processed into a sheet-like fiber product. By means of appropriate analysis algorithms which take into account the production process of the fiber product, the visual surface pattern can be precalculated from an image of a longitudinal portion of the fiber bundle. Only the visual appearance of the strand-like fiber bundle is therefore used as a parameter for simulating a visual surface pattern. A more detailed detection of a plurality of parameters of the fiber bundle may therefore be dispensed with entirely. The image of the fiber bundle can be detected in an automated manner, without the co-operation of an operator, and, in the case of stipulated analysis algorithms, leads quickly and accurately to a simulation of the final fiber product. An image is to be understood here as meaning any information means which stores the visual nature of a fiber strand, in particular the color spectrum of the fiber strand.

The development of the method according to the invention in which a running thread is sensed is particularly advantageous, so that an on-line determination of the carpet quality can be carried out in a process for producing a fiber strand, for example a BCF thread, from a plurality of individual colored threads.

In order to arrive at accurate theoretical surface patterns at as low an outlay as possible in computation terms, the developments of the method according to the invention, as claimed in Claims 3 and 4, are particularly advantageous. In this case, the longitudinal portions of the fiber bundle are plaited in a plurality of thread plies lying next to one another, in order to detect an extract of the thread plies as an image.

However, the longitudinal portions of the fiber bundle may also be wound into a bobbin, so that the image of at least one extract of the bobbin is detected.

The detection of the image of an extract of one of the end faces of the bobbin or of the complete end face of the bobbin has proved to be particularly advantageous. In this case, the longitudinal portions of the fiber bundle are laid closely to one another, so that the image information can be converted into the surface pattern of the fiber product by means of only a few computing operations.

The image is in this case advantageously recorded by one or more photocells, so that the signals from the photocells can be fed directly for image analysis. In this case, the light signals can be converted directly into electrical charges by means of the photocells. The digital data are fed to an image analysis unit which extract the required computation data by means of corresponding image analysis algorithms and transfer them to the evaluation electronics for calculating the visual surface patterns.

There is also the possibility, however, that the image is stored in each case as a digital pattern and the data of a plurality of digital patterns are fed to the image analysis unit.

The method according to the invention is particularly effective in the production of multi-colored yarns which serve for producing a color pattern in a fiber product. To that extent, the method variants according to Claims 9 and 10 are preferably employed.

In this case, integration into a production process of the fiber bundle according to Claims 12 and 13 is particularly advantageous, since the simulation results can be utilized directly for the setting and variation of process parameters in the production process of the fiber bundle. Thus, the process parameters of the production process of the fiber bundle can be influenced by a following process for producing a predetermined fiber product. In this case, in a first method variant, the changes of one or more process parameters can be generated in such a way that the simulated surface pattern is compared with a stored desired default surface pattern. It is also possible, however, to obtain corresponding process parameter generations from a straightforward analysis of the surface pattern.

In a second method variant, even the analysis of an image or a comparison of the image with a stored pattern image is utilized in order to generate changes of one or more process parameters.

The method according to the invention for simulating visual surface patterns of a fiber product thus makes it possible to have completely novel methods for the production of fiber bundles. The method according to the invention for producing a BCF yarn consisting of a plurality of differently colored multi-filament threads in a BCF spinning process is distinguished in that a BCF yarn is provided which delivers the desired surface patterns during further processing into a carpet. In this case, the simulation results can be evaluated, even before the start of the process, in order to define directly the process parameters for the spinning, drafting, crimping, swirling and winding of the threads. Furthermore, however, there is also the possibility, despite a selective process parameter setting, of carrying out continuous simulation during the process, in order to change the setting of at least one of the process parameters as a function of a simulation result.

Alternatively, in a simulation, monitoring and control can be carried out before the process start of the running production process in that an image of a longitudinal portion of the BCF yarn is detected and is compared with a stored pattern image. The setting of the parameter can then be changed as a function of the comparison.

Alternatively, however, there is also the possibility that a visual surface pattern of the carpet is calculated for every digitized data of the image, so that corresponding parameter changes can be carried out from a comparison with a desired default pattern of the carpet.

The apparatus according to the invention, as claimed in Claim 14, is distinguished by a simple arrangement which can be used in a flexible way. Thus, the image acquisition appliance for sensing the image of a longitudinal portion of the fiber bundle can advantageously also be employed in a production process of the fiber bundle. The image acquisition appliance can in this case detect the longitudinal portion of the fiber bundle in any desired positions within the process. The image acquisition appliance is advantageously assigned to a bobbin handling device or to the bobbin-winding machine of the production process.

In order to obtain a high resolution of the appearance of the fiber bundle, the image acquisition appliance is preferably equipped with one or more photocells which are arranged to form a surface sensor or a line sensor. CCD sensors of this type are particularly suitable for achieving maximum resolution and color reproduction qualities. The image acquisition appliance may in this case be assigned optics for light refraction or lighting means for light amplification.

For the direct processing of the sensor signals, the image acquisition appliance is connected to an image analysis device assigned to the evaluation device.

For incorporation into a production process of a fiber bundle, the evaluation electronics have directly an interface with respect to a control device by means of which the production process can be controlled. To that extent, direct data can be exchanged and parameter changes of the process parameters can be initiated without delay.

With incorporation into the production process, therefore, classifications of the bobbins produced can also advantageously be carried out, so that, in the processing of the bobbins into a carpet fabric, a high uniformity of the feed product can be achieved.

The apparatus according to the invention, as claimed in Claim 22, is particularly suitable for producing a composite thread from a plurality of visually different individual threads according to predetermined pattern maps in order to obtain a quality of the composite thread which is uniform for a subsequent sheet-like product. Particularly for the production of carpet yarns, a high uniformity of the visual properties can be achieved by means of the apparatus according to the invention. Thus, an image acquisition appliance is provided, so that an actual-value/desired-value comparison between maps of, for example, the color spectra can be carried out directly by coupling to an evaluation unit.

The development of the apparatus is particularly advantageous in which the image acquisition appliance is arranged upstream of the winding device in the thread run of the BCF thread. On-line monitoring for monitoring the uniformity of the projected thread is consequently achieved.

In order, during the production process, to assess possible deviations between an actual image and a pattern image and as far as possible transfer them directly into a simulated surface pattern, the development of the apparatus according to the invention is particularly advantageous in which the image acquisition appliance is assigned to a bobbin produced by means of the winding device. Thus, a longitudinal portion, plaited in a plurality of plies, of the fiber bundle can be detected and, if appropriate, converted to a surface pattern.

Independently of the arrangement of the image acquisition appliance, it is particularly advantageous if the evaluation device is coupled to a control device by means of which at least one process parameter can be changed. Consequently, possible deviations in the visual appearance of the fiber strand can be converted directly into process changes.

### BRIEF DESCRIPTION OF THE DRAWINGS

The inventive method will be described in more detail hereinbelow with the aid of an exemplary embodiment of the inventive apparatus, with reference to the accompanying drawings.

FIG. 1 illustrates diagrammatically a first exemplary embodiment of the apparatus according to the invention for carrying out a method according to the invention;

FIG. 2 illustrates diagrammatically a further exemplary embodiment of the apparatus according to the invention for carrying out a method according to the invention;

FIG. 3 illustrates diagrammatically a map of a longitudinal portion of a fiber bundle;

FIG. 4 illustrates diagrammatically a map of an extract of a bobbin;

FIG. 5 illustrates diagrammatically a visual surface pattern of a fiber product; and

FIG. 6 illustrates diagrammatically an apparatus according to the invention for carrying out a production method according to the invention for producing a BCF yarn.

### DETAILED DESCRIPTION OF PREFERRED EMBODIMENTS

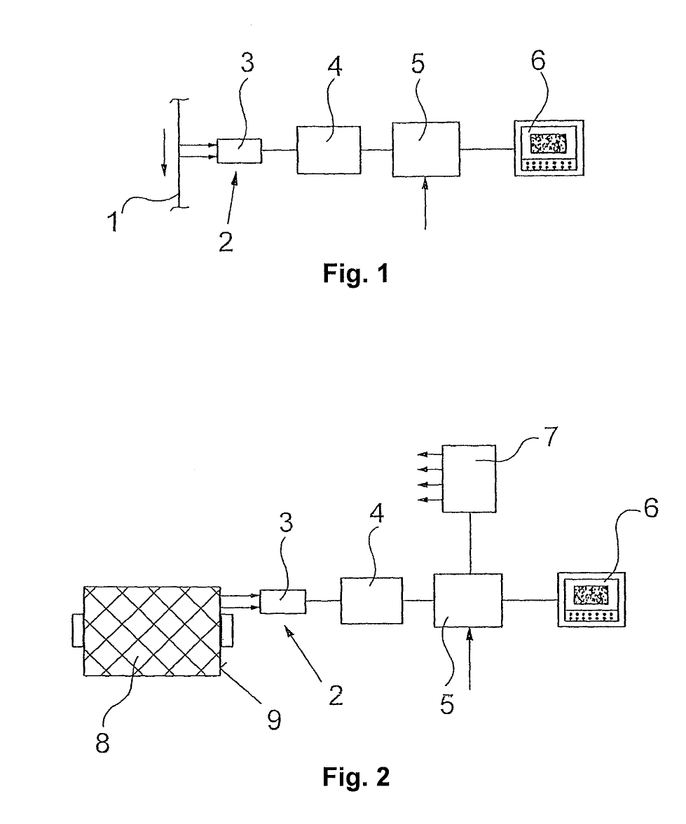

FIG. 1 shows diagrammatically a first exemplary embodiment of an apparatus according to the invention for carrying out the method according to the invention for simulating a visual surface pattern of a fiber product. The apparatus has a sensor device 2 which is arranged in the vicinity of a fiber bundle 1. The sensor device 2 is designed as an image acquisition appliance 3, by means of which an image of a longitudinal portion of the fiber bundle 1 is detected. The fiber bundle 1 may be sensed by the sensor device 2 as a stationarily clamped fiber sample or in a running process.

The sensor device 2 is coupled to an image analysis device 4 which is assigned to an evaluation device 5. The evaluation device 5 is coupled to a display device 6, by means of which an indication of results is possible.

In the exemplary embodiment, illustrated in FIG. 1, of the apparatus according to the invention, an image of a longitudinal portion of the fiber bundle 1 is detected. For this purpose, the image acquisition appliance 3 preferably has CCD sensors, by means of which the light signals can be converted directly into charges. The sensor signals are fed to the image analysis device 4, in which an image analysis unit carries out a treatment and analysis of the data and determines extracted computation data by means of appropriate algorithms. The extracted computation data are assigned to the evaluation device 5 which consists of evaluation electronics with corresponding computation software, in order to calculate a visual surface pattern of a fiber product by simulation. The visual surface pattern can then be indicated via the display device 6. The display device 6 used is preferably a monitor.

The apparatus, illustrated in FIG. 1, for carrying out the method according to the invention can be improved in the detection of the image in such a way that the image acquisition appliance 3 is assigned a lighting means in order to amplify the light signals emanating from the fiber bundle. For example, a laser could be used as lighting means. Optics may likewise be employed in order to make it possible to focus the light beams in order to generate the image.

FIG. 2 shows diagrammatically a further exemplary embodiment of an apparatus according to the invention for carrying out the method according to the invention. The design of the apparatus is essentially identical to the exemplary embodiment according to FIG. 1, and therefore reference is made to the abovementioned description and only the differences are explained at this juncture.

In the exemplary embodiment illustrated in FIG. 2, the longitudinal portion of the fiber bundle is wound into a bobbin 8. An extract of the end face 9 of the bobbin 8 is recorded as an image by the image acquisition appliance 3. The image may in this case extend either only over an extract or over the entire end face 9 of the bobbin 8. For this purpose, the image acquisition appliance can be guided movably in such a way that the end face is detected completely, for example by a line sensor.

The image acquisition appliance 3 is coupled to the image analysis device 4 and the evaluation device 5. The evaluation device 5 has an additional interface with respect to a control device 7 which is assigned, for example, to the production process of the fiber bundle. To that extent, there is a direct data connection between the evaluation device 5 and the control device 7, so that possible parameter changes of the production process can be carried out on the basis of the simulation results. At the same time, the evaluation device 5 is coupled to the display device 6, so that the simulated surface patterns can be indicated.

The apparatus illustrated in FIG. 2 can be used in a bobbin inspection station, for example so that bobbin sorting and classification can be carried out. It is also possible, however, to employ the apparatus directly in the production process of the fiber bundle, so that action can at the same time be taken in the process in an on-line connection.

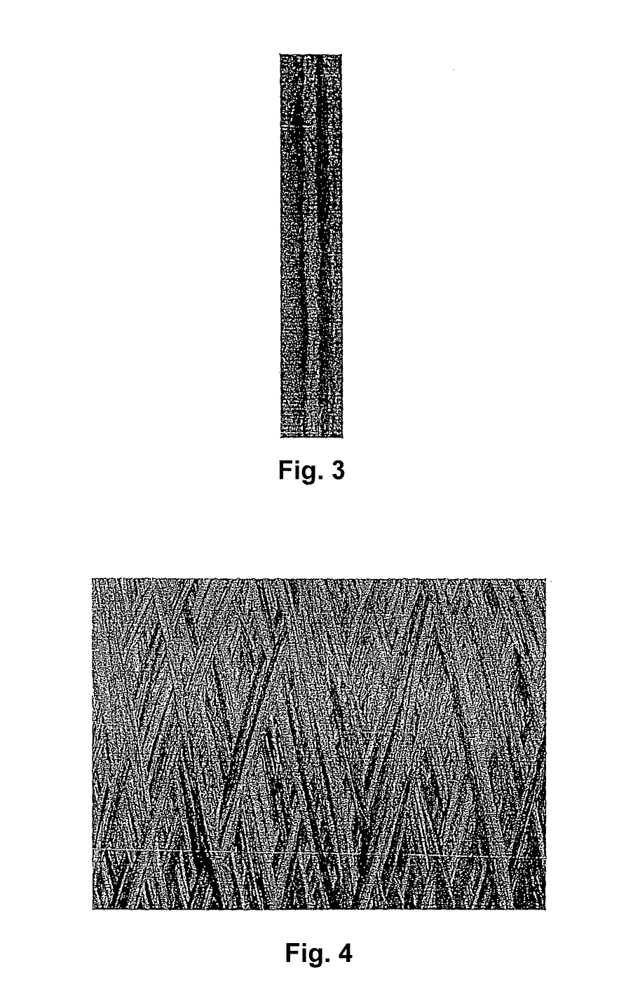

The apparatuses, illustrated in FIGS. 1 and 2, for carrying out the method according to the invention are based essentially on image processing. Thus, in the apparatus illustrated in FIG. 1, an image of the fiber bundle 1 is generated by the image acquisition appliance. FIG. 3 shows, as an example, a map of a multi-colored fiber bundle. The illustration in FIG. 3 is black/white, so that the color differences are reproduced in various gray tones. The fiber bundle is in this case a BCF yarn which is formed from, overall, three differently colored individual threads. The individual threads are formed, in turn, by a multiplicity of filaments. In the map illustrated in FIG. 3, it can be seen that the individual threads within the BCF yarn have a very low intermixing which, during subsequent further processing into a carpet, leads to a typical color pattern with clearly delimited colors. With the aid of image analysis, information can be generated from the image by means of the method according to the invention and is converted with the aid of analysis algorithms into a theoretical surface pattern. The simulated surface pattern thus makes it possible to have a simulation of the final fiber product. In the event that specific surface patterns are desired in the fiber product, in this case a carpet, variations can be carried out in the production process of the BCF yarn, for example in the intermixing of the individual threads in the BCF yarn. A predetermined surface pattern of the fiber product can therefore be obtained even during the production of the fiber bundle.

It should be expressly mentioned at this juncture that the image depicted in the invention is not to be equated to the map shown in FIG. 3. In this context, an analog or digital information means, by which the visual characteristic property of the fiber strand can be specified, is designated as an image. Thus, for example, in the case of a multi-colored thread, the image can be formed by a color spectrum which specifies the composition of the individual colors in the longitudinal portion of the fiber strand.

FIG. 4 shows an image of a part-view of a bobbin. In this case, the image shows a multiplicity of thread plies, the fractions of the fiber bundles being arranged next to one another and one above the other. The map already shows a surface pattern which has been formed by the winding of the fiber bundle. By means of corresponding analysis algorithms, which take into account, in particular, the process of the further processing of the fiber bundle into the fiber product, the information extracted from the map can be calculated with relatively low outlay in computation terms to form a surface pattern of the fiber product.

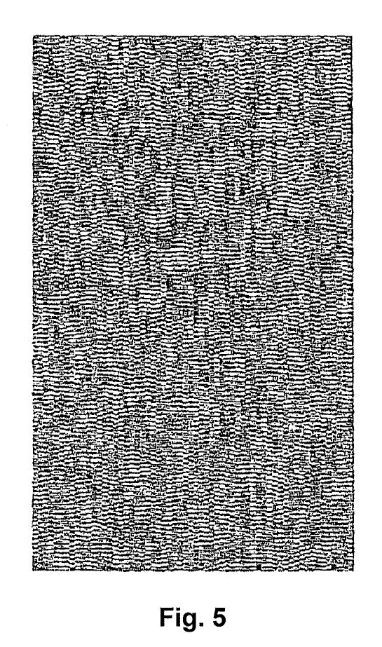

An example of a simulated surface pattern is illustrated in FIG. 5. This is a multi-colored surface pattern of a carpet which appears in the black/white map as a result of different gray tones. The surface pattern illustrated in FIG. 5 could have been calculated, for example, from the image of the fiber bundle illustrated in FIG. 3 or from the image of the bobbin illustrated in FIG. 4.

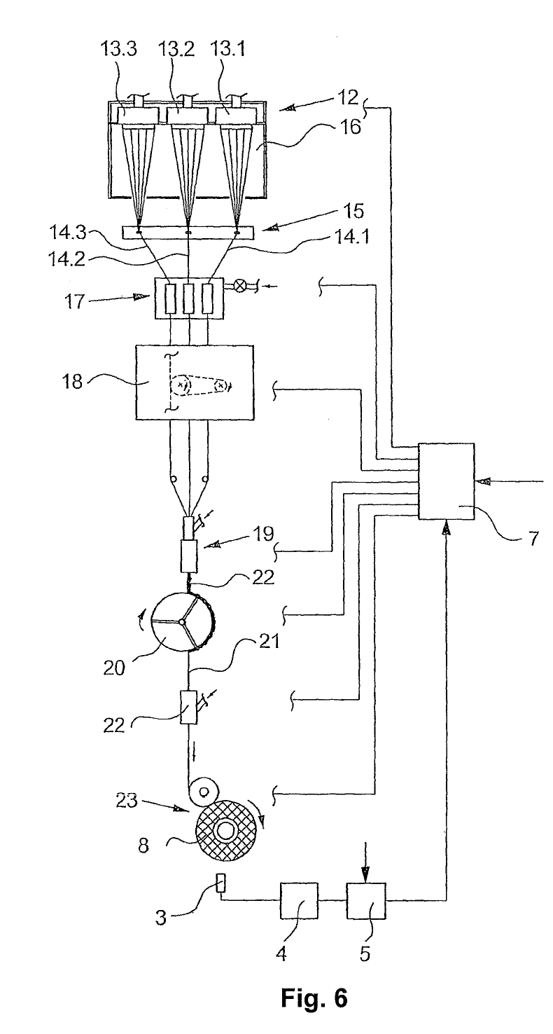

FIG. 6 illustrates an exemplary embodiment of an apparatus according to the invention of a BCF spinning process, in order to carry out the method according to the invention for producing a BCF yarn. For this purpose, the apparatus has a spinning device 12, in which a plurality of spinnerets are arranged next to one another for extruding a plurality of filament bundles. In this exemplary embodiment three spinnerets 13.1, 13.2 and 13.3 are arranged next to one another. Each of the spinnerets 13.1 to 13.3 is fed a colored polymer melt, a differently colored polymer melt being extruded in each of the spinnerets. Thus, for example, three differently colored filament bundles can be extruded simultaneously. Below the spinnerets 13.1 to 13.3 is provided a cooling device 16 for cooling the filament bundles which are combined in each case into a thread 14.1, 14.2 and 14.3 by means of a preparation device 15.

The threads 14.1, 14.2 and 14.3 are combined in parallel in a plurality of treatment stages and are crimped into a BCF yarn 21 by means of a crimping device 19. The treatment stages in this case contain a pretangling device 17 for the separate pretangling of the threads 14.1 to 14.3, and a take-up device 18 for taking up and drafting the threads. The crimping device 19 is in this case designed as a compressive crimping device, by means of which the threads 14.1 to 14.3 are textured into a thread plug. The thread plug is subsequently cooled via a cooling drum 20 and taken up to form the BCF yarn 21. Before winding by means of the winding device 23, a secondary swirling takes place by means of the secondary swirling device 22.

The BCF yarn 21 is wound into a bobbin 8 in the winding device. The bobbin 8 is assigned an image acquisition appliance 3, by means of which an image of an extract of the bobbin 8 is detected. The image acquisition appliance 3 is coupled to an image analysis device 4, by means of which the data of the image are analyzed and extracted. An analysis is carried out from the extracted computation data by means of the evaluation device 5. The evaluation device 5 is coupled to a control device 7 which controls the entire BCF spinning process.

In the exemplary embodiment, illustrated in FIG. 6, of the apparatus for producing a BCF yarn, different method variants can be implemented. In a first design variant, a pattern image of a desired bobbin view, which is compared with the actual image of the bobbin 8, could be stored in the evaluation device 5. In the event that inadmissible deviations are detected in the comparative analysis, the generation of a control command which is fed directly to the control device 7 takes place. Within the control device 7, one or more parameter changes of the process parameters could be determined and initiated on the basis of the control command. Thus, in particular, the nature of the individual threads and the intermixing of the threads into the BCF yarn may be influenced in such a way that a desired appearance of the bobbins 8 is achieved.

This method variant can also advantageously be utilized with a modified apparatus for on-line monitoring of a BCF yarn. In this case, the image acquisition appliance 3 is arranged in the region between the secondary swirling device 22 and the bobbin-winding device 23. This situation is illustrated by dashes in FIG. 6. The image acquisition appliance 3 is assigned directly to the running thread 21, so that a detection of an actual image of a defined longitudinal portion of the BCF yarn 21 takes place continuously. The actual image can be compared via the evaluation device 5 with a stored pattern image, for example a predefined color spectrum of the BCF yarn. By the evaluation device 5 being coupled to the control device 7, undesirable deviations between the actual image and the pattern image can in this case be converted into corresponding control signals in order to change one or more settings of process parameters. It is also possible, however, to indicate and document the deviation so that a classification of the bobbins produced can subsequently be carried out.

In a further alternative for carrying out the method, there is the possibility that a simulation calculation takes place in the evaluation device 5 from the computation data of the image, in order to determine the visual surface pattern of a carpet. The calculated surface pattern is compared with a stored desired default surface pattern. The desired parameter adaptations take place via the control device 7 as a function of the comparative analysis. The method variant can advantageously be implemented with both apparatus variants, so that both the sensed bobbin and the sensed thread can be utilized for on-line simulation.

In the exemplary embodiments, illustrated in FIG. 6, for carrying out the method according to the invention for producing a BCF yarn, there is also the possibility, however, that the settings of the process parameters are carried out before the process start as a function of a simulation calculation or as a function of an actual surface pattern of a carpet.

The method according to the invention and the apparatus according to the invention thus make it possible to have completely novel ways of producing fiber products which are processed into a surface pattern of a fiber product in a further processing process by knitting, weaving or plaiting. Thus, novel surface patterns of the fiber product can be created by means of simulations. The invention makes it possible to have fiber production manufacture aimed at the final product.

That which is claimed:

1. A method for simulating a visual surface pattern of a fiber product, said method comprising:
sensing at least one parameter of a strand-like fiber bundle;
digitizing the at least one parameter into data; and
converting the data of the at least one parameter into a surface pattern with the aid of evaluation electronics,
wherein sensing at least one parameter of the strand-like fiber bundle comprises detecting as an image a visual appearance of a longitudinal portion of the fiber bundle.

2. A method as claimed in claim 1, wherein the longitudinal portion of the fiber bundle is sensed on a continuously running thread and is converted into the image.

3. A method as claimed in claim 1, wherein the longitudinal portion of the fiber bundle is plaited in a plurality of thread plies lying next to one another, and an image of at least one extract of the thread plies is detected.

4. A method as claimed in claim 1, wherein the longitudinal portion of the fiber bundle is wound into a bobbin, and the image of at least one extract of the bobbin is detected.

5. A method as claimed in claim 4, wherein the image of an extract of one end face of the bobbin or of a complete end face of the bobbin is detected.

6. A method as claimed in claim 1, wherein the image is recorded by one or more photocells, and wherein one or more signals from the photocells are fed directly to an image analysis unit.

7. A method as claimed in claim 1, wherein the image is stored as a digital pattern, and wherein data of a plurality of digital patterns are fed simultaneously to an image analysis unit.

8. A method as claimed in claim 1, wherein the image analysis unit delivers extracted computation data which is converted with the aid of the evaluation electronics into the visual surface pattern.

9. A method as claimed in claim 1, wherein the surface pattern is indicated as an image on a monitor.

10. A method as claimed in claim 1, wherein the fiber bundle is formed as a BCF (Bulked Continuous Filament) yarn from a plurality of differently colored multi-filament threads.

11. A method as claimed in claim 10, wherein the surface pattern serves as a simulation of a fabric pattern of a carpet.

12. A method as claimed in claim 1, wherein the image is detected during a production process of the fiber bundle and wherein changes of one or more process parameters are generated by means of an analysis of the surface pattern or a comparison of the surface pattern with a stored desired default pattern.

13. A method as claimed in claim 1, wherein the image is detected during a production process of the fiber bundle and wherein changes of one or more process parameters are generated by means of an analysis of the image or a comparison of the image with a stored desired default image.

14. An apparatus for simulating a visual surface pattern of a fiber product, said apparatus comprising:
a sensor device for detecting a parameter of a thread bundle;
an evaluation device for determining a visual surface pattern of a fiber product; and
a display device for illustrating the surface pattern,
wherein the sensor device has an image acquisition appliance, by means of which an image of a longitudinal portion of the fiber bundle can be sensed.

15. An apparatus according to claim 14, wherein the image acquisition appliance contains at least one or more photocells which are arranged to form a surface sensor or a line sensor.

16. An apparatus according to claim 14, wherein the image acquisition appliance is assigned optics for light refraction or lighting means for light amplification.

17. An apparatus according to claim 14, wherein the image acquisition appliance is connected to an image analysis device assigned to the evaluation device.

18. A method for producing a BCF yarn consisting of a plurality of differently colored multi-filament threads in a BCF spinning process, in which the spinning, drafting, crimping, swirling and winding of the threads are determined by selectable process parameters, said method comprising:
simulating, before the start of the spinning process or during the spinning process, a visual surface pattern of a carpet by sensing at least one parameter of the BCF yarn, digitizing the at least one parameter into data, and converting the data of the at least one parameter into a surface pattern with the aid of evaluation electronics, wherein sensing at least one parameter of the BCF yarn comprises detecting as an image a visual appearance of a longitudinal portion of the fiber bundle, and
wherein a setting of at least one of the process parameters is selected or monitored as a function of the simulation result.

19. A method as claimed in claim 18, wherein a pattern image of a longitudinal portion of a thread is generated from the simulation results, wherein an actual image of a longitudinal portion of the BCF yarn is detected, wherein the actual image is compared with the stored pattern image, and wherein deviations between the actual image and the pattern image are indicated.

20. A method as claimed claim 19, wherein the signaled deviation between the actual image and the pattern image is converted into a change of the process parameter.

21. A method as claimed in claim 19, wherein the digitized data of the actual image is converted into the visual surface pattern of the carpet, and wherein the surface pattern is compared with a desired default pattern, and the setting of the parameter is changed as a function of the comparison.

22. An apparatus for producing a BCF yarn consisting of a plurality of differently colored multi-filament threads in a BCF spinning process, said apparatus comprising:
a spinning device for the melt-spinning of a plurality of colored threads;
a crimping device for texturing the threads into a BCF thread; and
a winding device,
wherein an image acquisition appliance for sensing a longitudinal portion of the BCF thread is present, and wherein the image acquisition appliance is connected to an evaluation device, by means of which a comparison between an actual image and a stored pattern image can be carried out and indicated.

23. An apparatus according to claim 22, wherein the image acquisition appliance is arranged upstream of the winding device in a thread run of the BCF thread.

24. An apparatus according to claim 22, wherein the image acquisition appliance is assigned to a bobbin produced by means of the winding device.

25. An apparatus as claimed in claim 22, wherein the evaluation device is coupled to a control device by means of which at least one process parameter can be changed.
